(19) United States
(12) Patent Application Publication
(10) Pub. No.: US 2015/0336195 A1
(43) Pub. Date: Nov. 26, 2015

(54) MOLTEN METAL DISCHARGING DEVICE AND METHOD FOR DISCHARGING MOLTEN METAL

(71) Applicant: Mitsubishi Electric Corporation, Tokyo (JP)

(72) Inventors: Keiichi KURAMOCHI, Tokyo (JP); Masayoshi SHINKAI, Tokyo (JP)

(73) Assignee: MITSUBISHI ELECTRIC CORPORATION, Tokyo (JP)

(21) Appl. No.: 14/531,278

(22) Filed: Nov. 3, 2014

(30) Foreign Application Priority Data
May 22, 2014 (JP) 2014-106387

(51) Int. Cl. B23K 3/06

(52) U.S. Cl. CPC B23K 3/0607

(57) ABSTRACT

A molten metal discharging device according to the present invention that discharges a molten metal and bonds components with the molten metal discharged includes: a syringe having a tube shape that houses the molten metal therein; a shaft that slides inside the syringe to press the molten metal; a heater (syringe heat insulating heater) that is provided around the syringe and heats the molten metal to maintain a molten state; and the syringe including a shaft sliding portion in which the shaft slides and a nozzle that has an inner diameter smaller than that of the shaft sliding portion and discharges the molten metal from an opening at a tip thereof, a rotation mechanism that rotates the syringe, a rotation center of the rotation being an extending direction of the nozzle, a coating that repels the molten metal being applied to an interior wall of the nozzle.

### BACKGROUND OF THE INVENTION

1. Field of the Invention

The present invention relates to a molten metal coating device and a molten metal discharging device and more particularly to a molten metal discharging device that discharges a molten metal and bonds components with the metal discharged.

2. Description of the Background Art

Molten metal discharging devices are used for coating electrodes of semiconductor elements (for example, Si chips or SiC chips) with a molten metal and bonding them to base plates or lead frames made of copper or the like. A molten metal discharging device generally includes, for example, a syringe made of glass and a shaft. With a tip of the syringe dipped in the molten metal, the shaft is pulled up to suck the molten metal by negative pressure inside the syringe. After the tip of the syringe is moved to a predetermined position, the shaft is pressed down to pressurize the inside of the syringe, to thereby discharge the molten metal (for example, see Japanese Patent Application Laid-Open No. 2011-194456).

In recent times, semiconductor elements have become increasingly miniaturized as the shift from Si chips to SiC chips. The miniaturization of the semiconductor elements also reduces areas of bonding portions. As the areas of the bonding portions decrease, the amount of molten metal necessary for bonding one portion is also reduced. In other words, it has been required to further stabilize the amount of one discharge of the molten metal (amount of one supply of the molten metal).

In the conventional molten metal discharging device, the shaft cannot be inserted into the tip portion of the syringe made of the glass. Thus, when the molten metal is extruded, the molten metal may remain in the tip portion of the syringe, resulting in the unstable amount of one discharge.

### SUMMARY OF THE INVENTION

It is an object of the present invention to provide a molten metal discharging device and a method for discharging a molten metal such that the amount of one discharge of the molten metal is stabilized.

A molten metal discharging device according to the present invention discharges a molten metal and bonds components with the molten metal discharged. The molten metal discharging device includes: a syringe having a tube shape that houses the molten metal therein; a shaft that slides inside the syringe to press the molten metal; and a heater that is provided around the syringe and heats the molten metal to maintain a molten state. The syringe includes a shaft sliding portion in which the shaft slides and a nozzle that has an inner diameter smaller than that of the shaft sliding portion and discharges the molten metal from an opening at a tip thereof. The molten metal discharging device further includes a rotation mechanism that rotates the syringe, a rotation center of the rotation being an extending direction of the nozzle. A coating that repels the molten metal is applied to an interior wall of the nozzle.

The molten metal discharging device and the method for discharging a molten metal can reduce a contact area between the syringe and the molten metal because the coating that repels the molten metal is applied to the inside of the nozzle at the tip of the syringe. Furthermore, upon the discharge of the molten metal, the rotation mechanism rotates the nozzle, to thereby reduce a contact resistance between the nozzle and the molten metal. In a state where the contact resistance between the nozzle and the molten metal is reduced, the shaft is lowered to pressurize the inside of the syringe, which allows for the discharge of the molten metal without leaving the molten metal in the syringe.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a molten metal discharging device according to a first preferred embodiment;

FIG. 2 is a diagram explaining a relationship between the molten metal discharging device according to the first preferred embodiment and a bonding portion;

FIGS. 3A and 3B are diagrams explaining a discharge operation of the molten metal discharging device according to the first preferred embodiment;

FIG. 4 is a diagram explaining a suction operation of the molten metal discharging device according to the first preferred embodiment;

FIG. 5 is a diagram showing a configuration of a molten metal discharging device according to a second preferred embodiment;

FIG. 6 is a diagram showing another configuration of the molten metal discharging device according to the second preferred embodiment;

FIGS. 7A and 7B are diagrams showing a configuration of a molten metal discharging device according to a third preferred embodiment;

FIG. 8 is a diagram showing a configuration of a nozzle of a molten metal discharging device according to a fourth preferred embodiment; and

FIG. 9 is a cross-sectional view showing a nozzle of a molten metal discharging device according to a fifth preferred embodiment.

### DESCRIPTION OF THE PREFERRED EMBODIMENTS

### First Preferred Embodiment

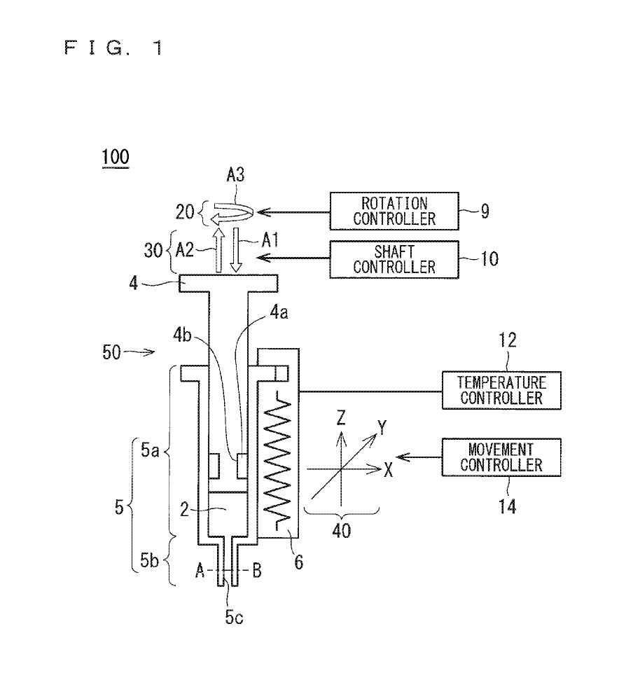

FIG. 1 is a diagram showing a schematic configuration of a molten metal discharging device 100 in a first preferred embodiment. The molten metal discharging device 100 includes a discharging mechanism part 50, a rotation controller 9, a shaft controller 10, a movement controller 14, and a temperature controller 12. Hereinafter, the same references indicate the same or corresponding portions in each diagram. The discharging mechanism part 50 includes a syringe 5, a shaft 4, a syringe heat insulating heater 6, a rotation mechanism 20, an actuator 30, and a movement mechanism 40.

The syringe 5 having a tube shape is formed of a shaft sliding portion 5a and a nozzle 5b. The nozzle 5b has an inner diameter smaller than an inner diameter of the shaft sliding portion 5a. The nozzle 5b sucks a molten metal 2 to house it inside the syringe 5. Moreover, the nozzle 5b discharges the molten metal 2 housed inside the syringe 5. The shaft 4 having a cylindrical shape slides along an inner side of the shaft sliding portion 5a of the syringe 5 to change pressure inside the syringe 5. A groove 4b is formed close to a tip of the shaft 4, and a sealing material 4a is embedded in the groove 4b. The syringe heat insulating heater 6 is built in a cylindrical block surrounding the syringe 5. In FIG. 1, the left side of the syringe heat insulating heater 6 is omitted to make the diagram easy to see.

The temperature controller 12 including a temperature sensor controls the syringe heat insulating heater 6 to maintain the temperature of the syringe 5 within the range of predetermined temperatures. In place of the syringe heat insulating heater 6, the syringe 5 may be heated by means of radiation, induction heating, convective heat transfer, or the like.

The shaft controller 10 controls the actuator 30 to slide the shaft 4 along the shaft sliding portion 5a of the syringe 5 in directions of arrows A1 and A2 in FIG. 1. Herein, the actuator 30 is actually attached on the shaft 4, but FIG. 1 shows it conceptually.

The rotation controller 9 controls the rotation mechanism 20 (for example, a motor) and rotates the syringe 5, a rotation center of the syringe 5 being an extending direction of the nozzle 5b in a direction of an arrow A3 (or opposite in direction to the arrow A3) in FIG. 1. The syringe 5 is rotated, and thus the shaft 4 disposed in the shaft sliding portion 5a of the syringe 5 is also rotated by following the rotation of the shaft sliding portion 5a. Herein, the rotation mechanism 20 is actually attached on the syringe 5, but FIG. 1 shows it conceptually.

The movement controller 14 controls the movement mechanism 40 and arbitrarily moves the discharging mechanism part 50 in, for example, directions of three axes of X, Y, and Z orthogonal to one another. Herein, the movement mechanism 40 is actually attached on the discharging mechanism part 50, but FIG. 1 shows it conceptually.

A material for the molten metal 2 can be preferably used as a brazing material for bonding. Molten metals are, for example, Sn, Pb, Zn, Ga, In, Bi, Au, Ag, Cu, or a mixture having these as main components, or alloys including one or more kinds among these.

A material for the syringe 5 is preferably a glass, a stainless steel, or the like in a case where the molten metal 2 is a solder having Sn or Pb as a main component, for example.

In this preferred embodiment, a coating 5c that repels the molten metal 2 is applied to an interior wall of the nozzle 5b. The coating 5c is, for example, a water repellent coating formed of a ceramic or a fluorine resin. In addition, a material that repels the molten metal 2 such as a molybdenum and a zirconia may be applied as the coating 5c. The coating 5c applied to the interior wall of the nozzle 5b prevents adhesion of the molten metal 2 (solder) to the nozzle 5b. This can prevent the molten solder from remaining in the nozzle 5b.

In a case where a material which is hard to convey heat such as a glass is used as a material for the syringe 5, the syringe heat insulating heater 6 is directly attached on the syringe 5 to heat the syringe 5. This can efficiently keep the molten metal 2 of the inside of the syringe 5 in the molten state.

A structure of the syringe 5 will be described in detail. The syringe 5 has two openings on the top and at the bottom. The shaft 4 is inserted into the opening on the upper side of the shaft sliding portion 5a, and the molten metal 2 is sucked and discharged from the opening on the lower side (tip of the nozzle 5b). An outer diameter of the shaft 4 is smaller than the inner diameter of the shaft sliding portion 5a of the syringe 5, thereby providing a gap therebetween. A size of the gap is designed for the shaft 4 to smoothly slide inside the shaft sliding portion 5a. An airtightness of the syringe 5 is maintained by the sealing material 4a.

The shaft 4 and the syringe 5 are formed of the same material, and thus the gap of the sliding portion of the shaft 4 and the syringe 5 can be maintained constant even in a case of heating the shaft 4 and the syringe 5. The gap is in the range of 0.05 mm to 0.1 mm or less. In other words, the diameter of the shaft 4 is designed to be smaller by the above-mentioned value than the inner diameter of the syringe 5 (namely, the inner diameter of the shaft sliding portion 5a). In this dimensional relationship, the sealing material 4a formed of the molten metal 2 fits in the groove 4b with stability, and thus the airtightness of the syringe 5 can be maintained with stability. Even if an oxide film of the molten metal 2 enters the gap between the shaft 4 and the syringe 5, the sliding resistance of the shaft 4 is not greatly affected because the oxide film is fragile. However, if the gap is smaller than the above-mentioned value, the oxide film is caught in the gap, thereby increasing the sliding resistance.

<Discharge Operation>

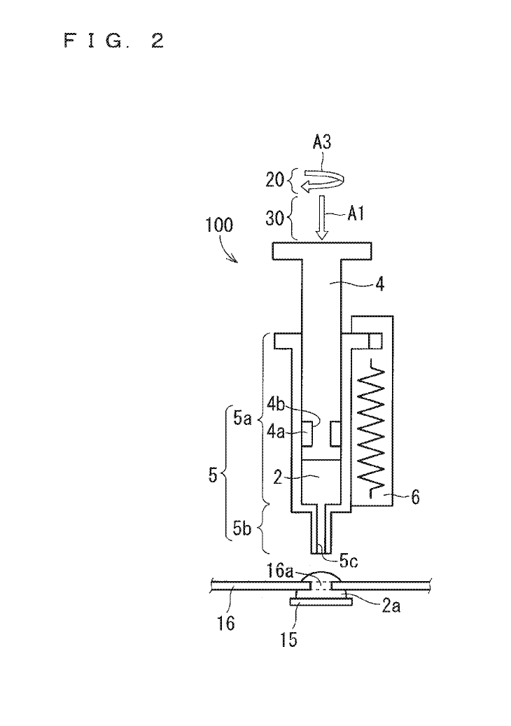

With reference to FIG. 2, a method for bonding a semiconductor chip 15 to a lead frame 16 using the molten metal discharging device 100 will be described. As shown in FIG. 2, the molten metal 2 is housed inside the syringe 5. In this state, the movement mechanism 40 as shown in FIG. 1 moves the discharging mechanism part 50 to a target position (namely, above a hole 16a of the lead frame 16). Then, the actuator 30 is activated to lower the shaft 4 in the direction of the arrow A1. At the same time, the rotation mechanism 20 rotates the syringe 5 once (arrow A3). A rotation center of the syringe 5 is the extending direction of the nozzle 5b. This operation discharges the molten metal 2 from the opening at the tip of the nozzle 5b. A discharged molten metal 2a coats the semiconductor chip 15 through the hole 16a provided in the lead frame 16. The discharged molten metal 2a is cooled and solidified, to thereby bond the semiconductor chip 15 and the lead frame 16.

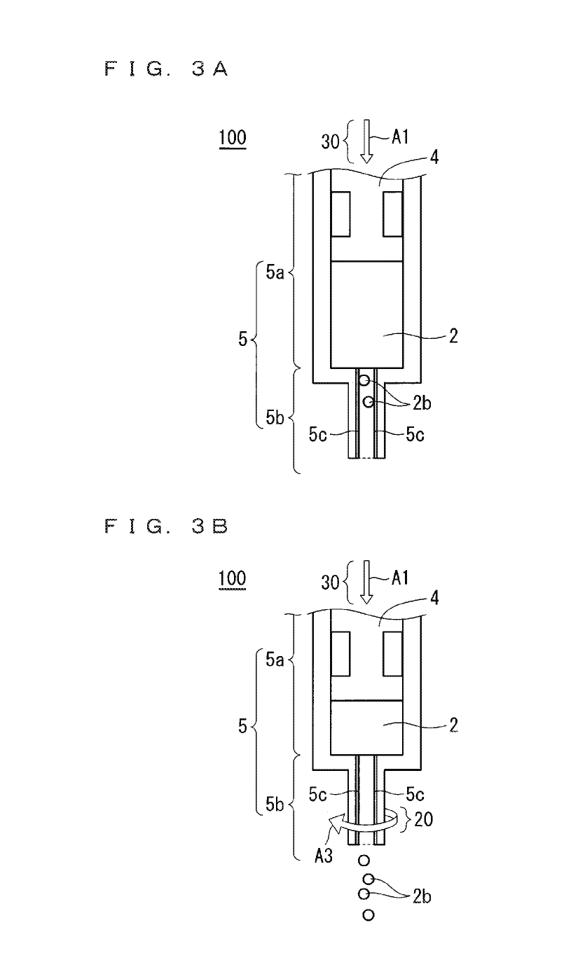

With reference to FIGS. 3A and 3B, the discharge operation of the molten metal discharging device 100 will be described in detail. First, the shaft controller 10 controls the operation of the actuator 30 to lower the shaft 4 in the direction of the arrow A1 in FIG. 3A. As the shaft 4 is pressed down, the pressure inside the syringe 5 increases, so that the molten metal 2 is pressed in the nozzle 5b. The coating 5c that repels the molten metal 2 is applied to the interior wall of the nozzle 5b. Therefore, as shown in FIG. 3A, molten metals 2b inside the nozzle 5b are repelled by the coating 5c and thus become spherical due to surface tension.

Next, as shown in FIG. 3B, the rotation controller 9 controls the operation of the rotation mechanism 20 and rotates the syringe 5 in the direction of the arrow A3 (or opposite in the direction to the arrow A3). At the same time, the shaft controller 10 controls the operation of the actuator 30 to lower the shaft 4 further (direction of the arrow A1). The rotation of the nozzle 5b holds the spherical molten metals 2b in the nozzle 5b without the rotation of the molten metals 2b. As a result, a contact resistance between the interior wall of the nozzle 5b and the spherical molten metals 2b can be further reduced. In this state, the shaft 4 is pressed down to pressurize the inside of the syringe 5, to thereby discharge the spherical molten metals 2b in the nozzle 5b from the opening at the tip of the nozzle 5b. At this time, the contact resistance between the interior wall of the nozzle 5b and the spherical molten metals 2b is reduced, so that all of the molten metals 2b held in the nozzle 5b are discharged.

To suppress oxidation of the molten metal 2, the molten metal discharging device 100 and the objects to be bonded (semiconductor chip 15 and lead frame 16) are placed in an atmosphere of non-oxidative gas. Herein, the non-oxidative gas is, for example, an inert gas such as a nitrogen or an argon, a reducing gas such as a hydrogen, or a mixture gas of the inert gas and the reducing gas.

<Suction Operation>

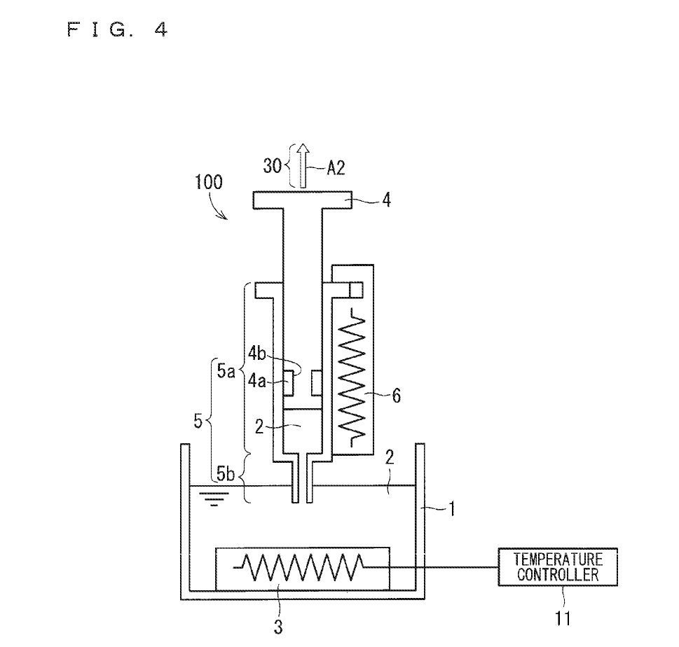

With reference to FIG. 4, an operation of sucking the molten metal 2 of the molten metal discharging device 100 will be described. A storage reservoir 1 stores the molten metal 2. A temperature controller 11 controls a reservoir heater 3 to maintain the molten metal 2 in the storage reservoir 1 within the range of predetermined temperatures. The molten metal discharging device 100, the storage reservoir 1, and the objects to be bonded (semiconductor chip 15 and lead frame 16) are disposed in an atmosphere furnace. The inside of the atmosphere furnace is filled with the non-oxidative gas. The atmosphere furnace causes the storage reservoir 1 to be in a low-oxygen atmosphere, to thereby suppress oxidation of the molten metal 2.

First, the atmosphere furnace and the inside of the syringe 5 are filled with the non-oxidative gas such as a nitrogen gas in advance. The storage reservoir 1 stores the molten metal 2 as the brazing material. The reservoir heater 3 maintains the molten metal 2 at a predetermined temperature. The syringe heat insulating heater 6 heats the syringe 5 to a temperature greater than or equal to the melting point of a bonding metal. The temperatures of the shaft 4 and the syringe 5 are maintained at temperatures greater than or equal to the melting point of the molten metal 2, so that the molten metal 2 of the storage reservoir 1 is housed in the molten state in the syringe 5. The shaft 4 is in a state of being pressed down to the bottom of the shaft sliding portion 5a of the syringe 5.

Next, the movement mechanism 40 shown in FIG. 1 moves the discharging mechanism part 50 including the syringe 5, and the nozzle 5b of the syringe 5 is immersed in the molten metal 2 stored in the storage reservoir 1. Then, the shaft controller 10 controls the actuator 20 to move the shaft 4 upwardly in the direction of the arrow A2. This reduces the pressure inside the syringe 5, and thus the molten metal 2 stored in the storage reservoir 1 is sucked into the inside of the syringe 5 through the nozzle 5b.

The amount of molten metal 2 sucked into the inside of the syringe 5 is the amount necessary for bonding the objects to be coated. The amount of suction can be increased or decreased by a stroke length of the shaft 4 moving upwardly. Moreover, the amount of discharge can be increased or decreased by a stroke length of the shaft 4 moving downwardly. In a case of coating a plurality of portions with the molten metal 2, the total amount of molten metal 2 necessary for coating is sucked in advance. The syringe 5 is moved to a first coating portion, and the shaft 4 is lowered by the stroke corresponding to the amount necessary for coating, to thereby discharge the molten metal 2. Then, the syringe 5 is moved to a next coating portion to discharge the molten metal 2 in a similar operation. This operation is repeated successively, whereby a plurality of portions can be easily coated. A series of operations as described above can be easily performed under automatic control.

In the first preferred embodiment as described above, the storage reservoir 1 and the discharging mechanism part 50 are formed separately. Furthermore, the suction intake for supplying the molten metal 2 and the discharge outlet for discharging the molten metal 2 are formed as the one nozzle 5b. The shaft 4 is moved upwardly, which reduces the internal pressure of the syringe 5 lower than the external pressure. The reduction in the pressure sucks the molten metal 2 from the nozzle 5b and houses the molten metal 2 in the inner space of the syringe 5. The shaft 4 is moved downwardly, which increases the internal pressure of the syringe 5 higher than the external pressure. The increase in the pressure discharges the molten metal 2 in the syringe 5 toward the objects to be coated. In this manner, the molten metal discharging device 100 of the first preferred embodiment has a simple configuration and can be provided at low prices.

In the first preferred embodiment, the storage reservoir 1 is disposed separately from the discharging mechanism part 50, whereby the discharging mechanism part 50 can be configured to be compact and lightweight. The movement mechanism 40 moves the discharging mechanism part 50 at high speed, which allows for a highly productive process. Furthermore, the arbitrary amount of molten metal 2 can be applied to an arbitrary position under the non-oxidative atmosphere, and thus a bonding of high quality can be obtained.

Surfaces of the shaft 4 and the syringe 5 in contact with the molten metal 2 are formed of a material, which does not chemically react with the molten metal 2, such as a metal having a nonconductive oxide film, a ceramic, and a glass. This prevents unnecessary components from mixing in the molten metal 2, so that the molten metal 2 can be applied in the component state similar to that at the time of suction. Therefore, a bonding portion bonded with the molten metal 2 can be prevented from deterioration.

Gas in contact with the molten metal 2 is the non-oxidative gas, whereby oxidation of the surface of the molten metal 2 can be prevented. If the surface of the molten metal 2 is oxidized, the oxide film is also discharged from the nozzle 5b. The oxide film is thus mixed in the bonding portion, thereby deteriorating a bonding quality. In contrast, in the first preferred embodiment, the above-mentioned configuration eliminates such concern, and thus the bonding of high quality can be obtained. Furthermore, in a case where the shaft 4 and the syringe 5 are formed of the same material, the gap of the shaft 4 and the syringe 5 can be maintained constant even if the syringe heat insulating heater 6 heats the syringe 5. This can secure the airtightness inside the syringe 5. With the gap maintained constant, the sliding resistance of the shaft 4 is not increased, whereby the amount of discharge of the molten metal 2 can be controlled with high accuracy.

The method for supplying the inside of the syringe 5 with the molten metal 2 may be a method for filling the molten metal 2 inside the syringe 5 from the opening at the top portion of the shaft sliding portion 5a in addition to the method for sucking the molten metal 2 from the nozzle 5b.

<Effects>

The molten metal discharging device 100 in the first preferred embodiment discharges the molten metal 2 and bonds the components with the molten metal 2 discharged. The molten metal discharging device 100 includes: the syringe 5 having the tube shape that houses the molten metal 2 therein; the shaft 4 that slides inside the syringe 5 to press the molten metal 2; and the heater (syringe heat insulating heater 6) that is provided around the syringe 5 and heats the molten metal 2 to maintain the molten state. The syringe 5 includes the shaft sliding portion 5a in which the shaft 4 slides and the nozzle 5b that has the inner diameter smaller than that of the shaft sliding portion 5a and discharges the molten metal 2 from the opening at the tip thereof. The molten metal discharging device 100 further includes the rotation mechanism 20 that rotates the syringe 5, a rotation center of the rotation being the extending direction of the nozzle 5b. The coating 5c that repels the molten metal 2 is applied to the interior wall of the nozzle 5b.

In the molten metal discharging device 100 of the first preferred embodiment, the coating 5c that repels the molten metal 2 is applied to the tip portion of the syringe 5 (namely, nozzle 5b). Thus, the shape of the molten metal 2 held inside the nozzle 5b becomes spherical due to the surface tension, whereby the contact area between the syringe 5 and the molten metal 2 can be reduced. Upon the discharge of the molten metal 2, the nozzle 5b is rotated to hold the spherical molten metal 2 in the nozzle 5b, resulting in the reduction in the contact resistance between the interior wall of the nozzle 5b and the molten metal 2. In a state where the contact resistance between the nozzle 5b and the molten metal 2 is reduced, the shaft 4 is lowered to pressurize the inside of the syringe 5, to thereby discharge the molten metal 2. In the operation as described above, the molten metal 2 in the nozzle 5b is discharged. The molten metal discharging device 100 of the first preferred embodiment can suppress the molten metal 2 to be remained in the nozzle 5b, thereby reducing variations in the amount of discharge of the molten metal 2. Therefore, the amount of discharge of the molten metal 2 can be controlled with high accuracy.

The method for discharging a molten metal in the first preferred embodiment uses the molten metal discharging device 100 that discharges the molten metal 2 and bonds the components with the molten metal 2 discharged. The molten metal discharging device 100 includes: the syringe 5 having a tube shape that houses the molten metal 2 therein; the shaft 4 that slides inside the syringe 5 to press the molten metal 2; and the heater (syringe heat insulating heater 6) that is provided around the syringe 5 and heats the molten metal 2 to maintain the molten state. The syringe 5 includes the shaft sliding portion 5a in which the shaft 4 slides and the nozzle 5b that has the inner diameter smaller than that of the shaft sliding portion 5a and discharges the molten metal 2 from the opening at the tip thereof. The molten metal discharging device 100 further includes the rotation mechanism 20 that rotates the syringe 5, a rotation center of the rotation being the extending direction of the nozzle 5b. The coating 5c that repels the molten metal 2 is applied to the interior wall of the nozzle 5b. The method for discharging a molten metal includes the steps of (a) rotating the syringe 5 and the shaft 4 by the rotating mechanism 20 in a state where the nozzle 5b holds the molten metal 2 therein and (b) sliding the shaft 4 toward the nozzle 5b to extrude the molten metal 2 from the opening of the nozzle 5b. The step (a) and the step (b) are performed simultaneously.

Therefore, upon the discharge of the molten metal 2, the nozzle 5b is rotated to hold the molten metal 2 in the nozzle 5b, resulting in the further reduction in the contact resistance between the interior wall of the nozzle 5b and the molten metal 2. In a state where the contact resistance between the nozzle 5b and the molten metal 2 is reduced, the shaft 4 is lowered to pressurize the inside of the syringe 5, to thereby discharge the molten metal 2. In the operation as described above, the molten metal 2 in the nozzle 5b is discharged. The method for discharging a molten metal in the first preferred embodiment can suppress the molten metal 2 to be remained in the nozzle 5b, thereby reducing variations in the amount of discharge of the molten metal 2. Therefore, the amount of discharge of the molten metal 2 can be controlled with high accuracy.

### Second Preferred Embodiment

<Configuration>

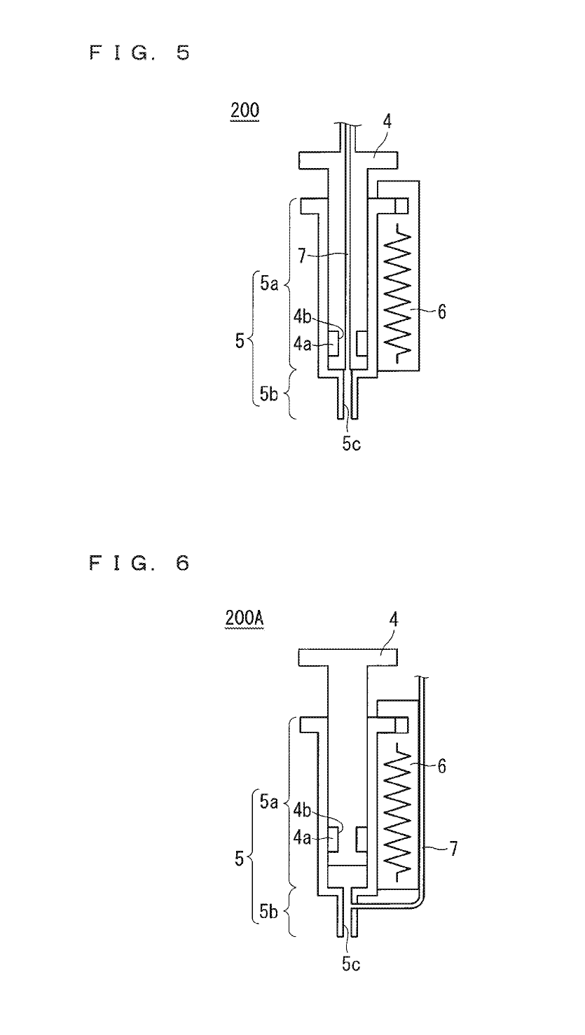

FIG. 5 is a diagram showing a configuration of a molten metal discharging device 200 in a second preferred embodiment. In the second preferred embodiment, a gas piping 7 is further provided in the shaft 4 in the molten metal discharging device 100 (FIG. 1) of the first preferred embodiment. The gas piping 7 is connected to a gas tank which is not shown, and the gas tank is filled with an inert gas such as a nitrogen. The configuration enables the inert gas to be injected into the nozzle 5b through the gas piping 7. The other configuration is the same as that in the first preferred embodiment, so that description will be omitted. In FIG. 5, the rotation mechanism 20, the actuator 30, the movement mechanism 40, the rotation controller 9, the shaft controller 10, the movement controller 14, and the temperature controller 12 in FIG. 1 are omitted. The same applies to FIGS. 6 to 8.

<Operation>

In the molten metal discharging device 200 of the second preferred embodiment, the gas piping 7 is provided in the shaft 4, so that the inert gas is heated by the syringe heat insulating heater 6 when passing through the gas piping 7. When the shaft 4 is lowered to discharge the molten metal 2 inside the nozzle 5b, the heated inert gas is sprayed onto the inside of the nozzle 5b from the gas piping 7. The pressure of the inert gas extrudes the molten metal 2 from the opening of the nozzle 5b. This can more reliably prevent the molten metal 2 from remaining inside the nozzle 5b. Moreover, the inert gas is heated, preventing the molten metal 2 from being cooled to be solidified.

FIG. 6 shows a configuration of another molten metal discharging device 200A in the second preferred embodiment. As shown in FIG. 6, instead of providing the gas piping 7 in the shaft 4, the gas piping 7 may be provided outside the syringe 5 to be connected to the nozzle 5b. To heat the inert gas, the gas piping 7 is provided to be in contact with the syringe heat insulating heater 6.

<Effects>

The molten metal discharging device 200 in the second preferred embodiment further includes the gas piping 7 for spraying the gas (namely, the inert gas) onto the inside of the nozzle 5b.

Thus, as with the molten metal discharging devices 200 and 200A of the second preferred embodiment, even if the configuration does not allow the shaft 4 to be inserted into the tip of the syringe 5 (namely, nozzle 5b) and causes a dead volume, the inert gas is sprayed onto the inside of the nozzle 5b through the gas piping 7 upon the discharge of the molten metal 2, which can prevent the molten metal 2 from remaining inside the nozzle 5b.

The method for discharging a molten metal in the second preferred embodiment further includes the step of spraying the inert gas onto the inside of the nozzle 5b through the gas piping 7 after the step of sliding the shaft 4 toward the nozzle 5b to extrude the molten metal 2 from the opening of the nozzle 5b.

Therefore, in the second preferred embodiment, after the shaft 4 is pressed down to discharge the molten metal 2 from the nozzle 5b, the inert gas is furthermore sprayed onto the inside of the nozzle 5b. Consequently, even if the molten metal 2 remains in the nozzle 5b, the molten metal 2 can be reliably discharged from the nozzle 5b.

### Third Preferred Embodiment

<Configuration>

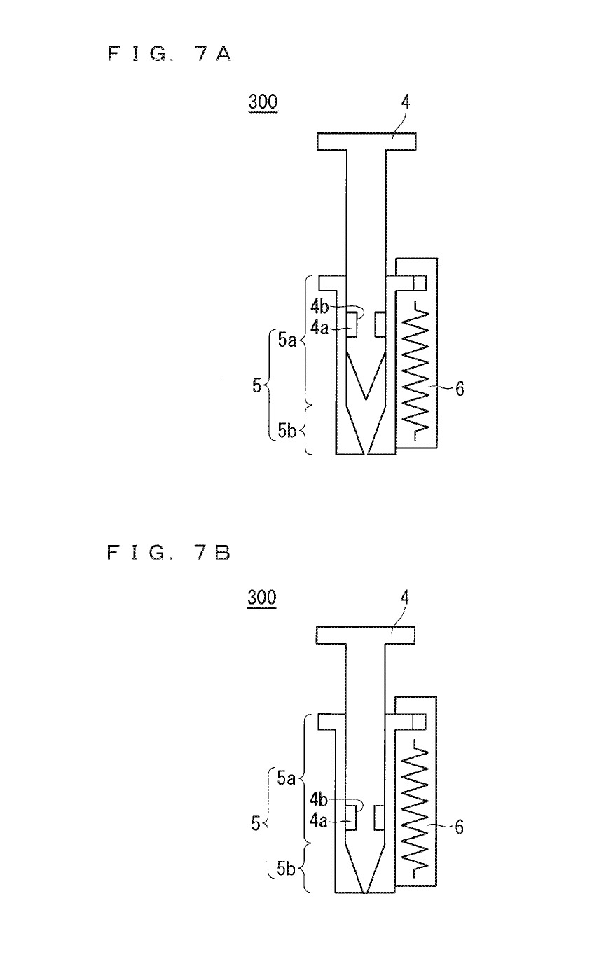

FIGS. 7A and 7B are diagrams showing a configuration of a molten metal discharging device 300 in a third preferred embodiment. FIG. 7A shows a state where the shaft 4 is moved upwardly, and FIG. 7B shows a state where the shaft 4 is lowered to the tip of the nozzle 5b.

As shown in FIG. 7A, a cross section of the inside of the nozzle 5b along the extending direction of the nozzle 5b has a shape that tapers down toward an opening. Specifically, the inside of the nozzle 5b has a conical shape, for example. The shaft 4 has a tip having a tapered shape. As shown in FIG. 7B, the tip of the shaft 4 has a shape that fits into the inside of the nozzle 5b without a gap. The shape of the inside of the nozzle 5b may be a triangular pyramid or a quadrangular pyramid other than the conical shape. The other configuration is the same as that in the first preferred embodiment, so that description will be omitted.

<Operation>

When the shaft 4 is lowered to discharge the molten metal 2 in the nozzle 5b, the tip of the shaft 4 fits into the nozzle 5b. This eliminates the gap between the inside of the nozzle 5b and the shaft 4, so that all of the molten metal 2 inside the nozzle 5b is discharged. In other words, the molten metal 2 can be reliably prevented from remaining inside the nozzle 5b.

<Effects>

In the molten metal discharging device 300 of the third preferred embodiment, the cross section of the nozzle 5b along the extending direction of the nozzle 5b has the shape that tapers down toward the opening, the shaft has the tip having the tapered shape, and the tip of the shaft 4 fits into the nozzle 5b without a gap.

Therefore, upon the discharge of the molten metal 2, the tip of the shaft 4 can fit into the nozzle 5b without a gap, so that the nozzle 5b and the shaft 4 do not have the dead volume therebetween. Thus, the molten metal 2 does not remain inside the nozzle 5b, whereby the amount of one discharge can be controlled with high accuracy.

In the method for discharging a molten metal of the third preferred embodiment, the tip of the shaft 4 fits into the nozzle 5b in the step of sliding the shaft 4 toward the nozzle 5b to extrude the molten metal 2 from the opening of the nozzle 5b.

Therefore, when the shaft 4 is pressed down to discharge the molten metal 2, the tip of the shaft 4 fits into the nozzle 5b without a gap, to thereby prevent the molten metal 2 from remaining in the nozzle 5b. The molten metal 2 does not remain inside the nozzle 5b, whereby the amount of one discharge can be controlled with high accuracy.

### Fourth Preferred Embodiment

<Configuration>

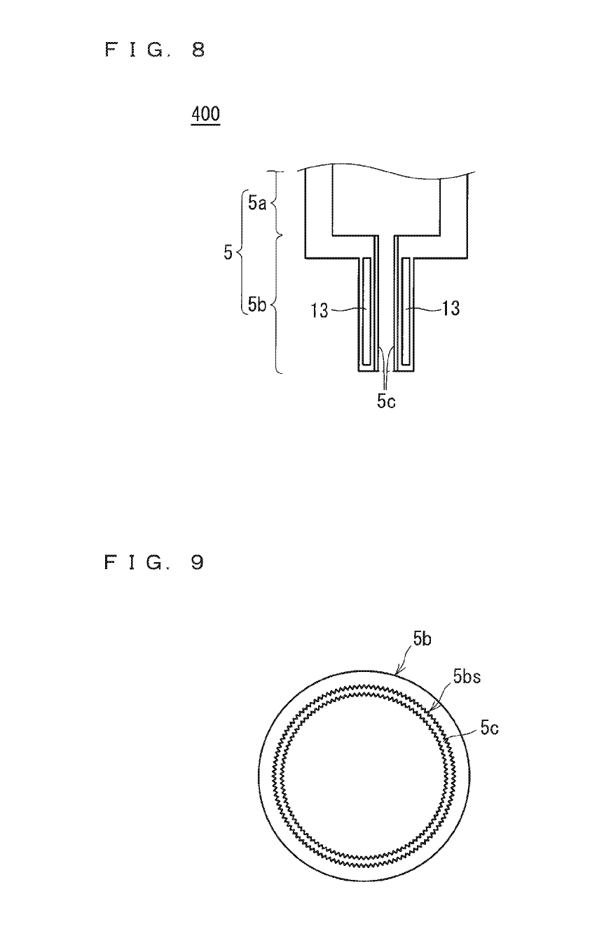

FIG. 8 is a diagram showing a configuration of a nozzle 5b of a molten metal discharging device 400 in a fourth preferred embodiment. In the fourth preferred embodiment, a nozzle heater 13 is embedded in the nozzle 5b. The other configuration is the same as that in the first preferred embodiment (FIG. 1), so that description will be omitted.

<Operation>

In the molten metal discharging device 400 of this preferred embodiment, the nozzle heater 13 heats the nozzle 5b, so that the molten metal 2 inside the nozzle 5b is reliably maintained in the molten state. Consequently, coagulation and adhesion of the molten metal 2 to the interior wall of the nozzle 5b, which are resulted from a decrease in viscosity of the molten metal 2 by cooling, do not occur. All of the molten metal 2 is thus discharged without remaining inside the nozzle 5b.

In the fourth preferred embodiment, the nozzle heater 13 is provided to be embedded in the nozzle 5b, so that the nozzle 5b has the same shape as that in the first preferred embodiment. Thus, upon the suction of the molten metal 2, the heater 13 does not prevent the suction.

<Effects>

The molten metal discharging device 400 in the fourth preferred embodiment further includes the nozzle heater 13 embedded in the nozzle 5b.

Therefore, the molten metal 2 held inside the nozzle 5b can be reliably maintained in the molten state by heating with the nozzle heater 13. This can suppress the coagulation and adhesion of the molten metal 2 to the interior wall of the nozzle 5b, resulted from cooling of the molten metal 2. Thus, the molten metal 2 can be more reliably prevented from remaining inside the nozzle 5b.

### Fifth Preferred Embodiment

FIG. 9 is a cross-sectional view showing a nozzle 5b of a molten metal discharging device in this preferred embodiment. The cross-sectional view corresponds to the cross section taken along a line segment AB in FIG. 1. In the first preferred embodiment, the coating 5c is applied to the inside of the nozzle 5b. Meanwhile, in the fifth preferred embodiment, fine irregularities 5bs are provided in the interior wall of the nozzle 5b and have the coating 5c applied thereon. The other configuration is the same as that in the first preferred embodiment, so that description will be omitted. In this preferred embodiment, the fine irregularities 5bs provided in the interior wall of the nozzle 5b are formed, for example, by polishing the interior wall of the nozzle 5b with an abrasive having appropriate roughness. The fine irregularities 5bs may also be formed by chemically polishing with a hydrofluoric acid or the like.

<Effects>

In the molten metal discharging device of the fifth preferred embodiment, the fine irregularities 5bs are provided in the interior wall of the nozzle 5b. The coating 5c that repels the molten metal is applied to the irregularities 5bs.

Therefore, the fine irregularities 5bs are provided in the interior wall of the nozzle 5b and have the coating 5c applied thereon, whereby the molten metal 2 can be repelled strongly by lotus effect. Thus, the molten metal 2 can be more reliably prevented from remaining inside the nozzle 5b.

In addition, according to the present invention, the above preferred embodiments can be arbitrarily combined, or each preferred embodiment can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A molten metal discharging device that discharges a molten metal and bonds components with said molten metal discharged, said molten metal discharging device comprising:
a syringe having a tube shape that houses said molten metal therein;
a shaft that slides inside said syringe to press said molten metal;
a heater that is provided around said syringe and heats said molten metal to maintain a molten state; and
said syringe including a shaft sliding portion in which said shaft slides and a nozzle that has an inner diameter smaller than that of said shaft sliding portion and discharges said molten metal from an opening at a tip thereof,
a rotation mechanism that rotates said syringe, a rotation center of the rotation being an extending direction of said nozzle,
wherein a coating that repels said molten metal is applied to an interior wall of said nozzle.

2. The molten metal discharging device according to claim 1, further comprising a gas piping for spraying gas onto the inside of said nozzle.

3. The molten metal discharging device according to claim 1, wherein
a cross section of said nozzle along the extending direction of said nozzle has a shape that tapers down toward the opening,
said shaft has a tip having a tapered shape, and
the tip of said shaft fits into said nozzle without a gap.

4. The molten metal discharging device according to claim 1, further comprising a nozzle heater embedded in said nozzle.

5. The molten metal discharging device according to claim 1, wherein
fine irregularities are provided in the interior wall of said nozzle, and
a coating that repels said molten metal is applied to said irregularities.

6. A method for discharging a molten metal using a molten metal discharging device that discharges said molten metal and bonds components with said molten metal discharged,
said molten metal discharging device comprising:
a syringe having a tube shape that houses said molten metal therein;
a shaft that slides inside said syringe to press said molten metal;
a heater that is provided around said syringe and heats said molten metal to maintain a molten state; and
said syringe including a shaft sliding portion in which said shaft slides and a nozzle that has an inner diameter smaller than that of said shaft sliding portion and discharges said molten metal from an opening at a tip thereof,
a rotation mechanism that rotates said syringe, a rotation center of the rotation being an extending direction of said nozzle,
wherein a coating that repels said molten metal is applied to an interior wall of said nozzle,
said method for discharging a molten metal comprising the steps of:
(a) rotating said syringe by said rotating mechanism in a state where said nozzle holds said molten metal therein; and
(b) sliding said shaft toward said nozzle to extrude said molten metal from the opening of said nozzle,
wherein said step (a) and said step (b) are performed simultaneously.

7. The method for discharging a molten metal according to claim 6, wherein
said molten metal discharging device further comprises a gas piping for spraying an inert gas onto the inside of said nozzle, and
said method for discharging a molten metal further comprises the step of (c) spraying said inert gas onto the inside of said nozzle through said gas piping after said step (b).

8. The method for discharging a molten metal according to claim 6, wherein
in said molten metal discharging device, a cross section of said nozzle along the extending direction of said nozzle has a shape that tapers down toward the opening,
said shaft has a tip having a tapered shape,
the tip of said shaft fits into said nozzle without a gap, and
said step (b) includes fitting the tip of said shaft into said nozzle.

9. The method for discharging a molten metal according to claim 6, wherein
said molten metal discharging device further comprises a nozzle heater embedded in said nozzle, and
in said step (a) and said step (b), said nozzle heater is activated.

10. The method for discharging a molten metal according to claim 6, wherein
in said molten metal discharging device, fine irregularities are provided in an inner surface of said nozzle, and
a coating that repels said molten metal is applied to said irregularities.
